(19) United States
(12) Patent Application Publication
(10) Pub. No.: US 2023/0171792 A1
(43) Pub. Date: Jun. 1, 2023

(54) METHOD AND APPARATUS FOR SIDELINK COMMUNICATION

(71) Applicant: LENOVO (BEIJING) LIMITED, Beijing (CN)

(72) Inventors: Zhennian Sun, Chaoyang District (CN); Xiaodong Yu, Haidian District (CN); Haipeng Lei, Haidian District (CN); Xin Guo, Chaoyang District (CN); Haiming Wang, Xicheng District (CN)

(73) Assignee: Lenovo (Beijing) Ltd., Beijing (CN)

(21) Appl. No.: 17/912,454

(22) PCT Filed: Mar. 18, 2020
(86) PCT No.: PCT/CN2020/079985

§ 371 Date: Sep. 16, 2022

(51) Int. Cl. H04W 72/40; H04W 72/02; H04W 72/25; H04W 72/0446

(52) U.S. Cl. CPC H04W 72/40; H04W 72/02; H04W 72/25; H04W 72/0446

(57) ABSTRACT

The subject disclosure relates to a method and apparatus for sidelink communication. One embodiment of the subject disclosure provides a method performed by a first User Equipment (UE), comprising: determining a first set of sidelink resources based on a communication status of the first UE or based on a sensing result of the first UE; and transmitting a signal indicating the first set of sidelink resources to a second UE.

### TECHNICAL FIELD

The subject application relates to sidelink communication, and more specifically relates to determining sidelink resources during sidelink communication.

### BACKGROUND OF THE INVENTION

Vehicle to everything (V2X) has been introduced into 5G wireless communication technology. In terms of a channel structure of V2X communication, a direct link between two User Equipments (UEs) is called a sidelink (SL). Sidelink is a long-term evolution (LTE) feature introduced in 3GPP Release 12, and enables a direct communication between proximal UEs, and data does not need to go through a base station (BS) or a core network.

In order to enhance the reliability and reduce latency of the sidelink communication, it is desirable to further improve the inter-UE coordination.

### SUMMARY

One embodiment of the subject application provides a method performed by a first User Equipment (UE), comprising: determining a first set of sidelink resources based on a communication status of the first UE or based on a sensing result of the first UE; and transmitting a signal indicating the first set of sidelink resources to a second UE.

Another embodiment of the subject application provides a method performed by a second User Equipment (UE), comprising: receiving a signal indicating a first set of sidelink resources from a first UE; and selecting a third set of sidelink resources from a group of sidelink resources which includes the first set of sidelink resources and a second set of sidelink resources determined by the second UE.

Yet another embodiment of the subject application provides an apparatus, comprising: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the method performed by a first User Equipment (UE), comprising: determining a first set of sidelink resources based on a communication status of the first UE or based on a sensing result of the first UE; and transmitting a signal indicating the first set of sidelink resources to a second UE.

Still another embodiment of the subject application provides an apparatus, comprising: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the method performed by a second User Equipment (UE), comprising: receiving a signal indicating a first set of sidelink resources from a first UE; and selecting a third set of sidelink resources from a group of sidelink resources which includes the first set of sidelink resources and a second set of sidelink resources determined by the second UE.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates an exemplary V2X communication system 100 in accordance with some embodiments of the present disclosure.

FIGS. 2(a), 2(b), 2(c), and 2(d) illustrate four different coverage scenarios 200(a), 200(b), 200(c), and 200(d).

FIG. 3 illustrates some sidelink resources in time domain according to some preferred embodiments of the subject disclosure.

FIG. 4 illustrates some sidelink resources in time domain and resources in frequency domain according to some preferred embodiments of the subject disclosure.

FIGS. 5(a), 5(b), and 5(c) illustrate some resources selection methods 500(a), 500(b), and 500(c) according to some preferred embodiments of the subject disclosure.

FIG. 6 illustrates a method performed by a UE for wireless communication according to a preferred embodiment of the subject disclosure.

FIG. 7 illustrates a method performed by a UE for wireless communication according to a preferred embodiment of the subject disclosure.

FIG. 8 illustrates a block diagram of a UE according to the embodiments of the subject disclosure.

### DETAILED DESCRIPTION

The detailed description of the appended drawings is intended as a description of the preferred embodiments of the present invention, and is not intended to represent the only form in which the present invention may be practiced. It should be understood that the same or equivalent functions may be accomplished by different embodiments that are intended to be encompassed within the spirit and scope of the present invention.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE Release 8 and so on. It is contemplated that along with developments of network architectures and new service scenarios, all embodiments in the present application are also applicable to similar technical problems; and moreover, the terminologies recited in the present application may change, which should not affect the principle of the present application.

UE(s) under new radio (NR) V2X scenario may be referred to as V2X UE(s). A V2X UE, which transmits data according to sidelink resource(s) scheduled by a base station (BS), may be referred to as a UE for transmitting, a transmitting UE, a transmitting V2X UE, a Tx UE, a V2X Tx UE, a SL Tx UE, or the like. A V2X UE, which receives data according to sidelink resource(s) scheduled by a BS, may be referred to as a UE for receiving, a receiving UE, a receiving V2X UE, a Rx UE, a V2X Rx UE, a SL Rx UE, or the like.

V2X UE(s) may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), internet of things (IoT) devices, or the like.

According to some embodiments of the present application, V2X UE(s) may include a portable wireless communication device, a smart phone, a cellular telephone, a flip phone, a device having a subscriber identity module, a personal computer, a selective call receiver, or any other device that is capable of sending and receiving communication signals on a wireless network.

According to some embodiments of the present application, V2X UE(s) includes wearable devices, such as smart watches, fitness bands, optical head-mounted displays, or the like. Moreover, V2X UE(s) may be referred to as a subscriber unit, a mobile, a mobile station, a user, a terminal, a mobile terminal, a wireless terminal, a fixed terminal, a subscriber station, a user terminal, or a device, or described using other terminology used in the art. V2X UE(s) may communicate directly with BS(s) via uplink (UL) communication signals.

A BS under NR V2X scenario may be referred to as a base unit, a base, an access point, an access terminal, a macro cell, a Node-B, an enhanced Node B (eNB), a gNB, a Home Node-B, a relay node, a device, a remote unit, or by any other terminology used in the art. A BS may be distributed over a geographic region. Generally, a BS is a part of a radio access network that may include one or more controllers communicably coupled to one or more corresponding base stations.

A BS is generally communicably coupled to one or more packet core networks (PCN), which may be coupled to other networks, like the packet data network (PDN) (e.g., the Internet) and public switched telephone networks, among other networks. These and other elements of radio access and core networks are not illustrated but are well known generally by those having ordinary skill in the art. For example, one or more BSs may be communicably coupled to a mobility management entity (MME), a serving gateway (SGW), and/or a packet data network gateway (PGW).

A BS may serve a number of V2X UEs within a serving area, for example, a cell or a cell sector via a wireless communication link. A BS may communicate directly with one or more of V2X UEs via communication signals. For example, a BS may serve V2X UEs within a macro cell.

Sidelink communication between a Tx UE and a Rx UE under NR V2X scenario includes groupcast communication, unicast communication, or broadcast communication.

Embodiments of the present application may be provided in a network architecture that adopts various service scenarios, for example but is not limited to, 3GPP 3G, long-term evolution (LTE), LTE-Advanced (LTE-A), 3GPP 4G, 3GPP 5G NR (new radio), 3GPP LTE Release 12 and onwards, etc. It is contemplated that along with the 3GPP and related communication technology development, the terminologies recited in the present application may change, which should not affect the principle of the present application.

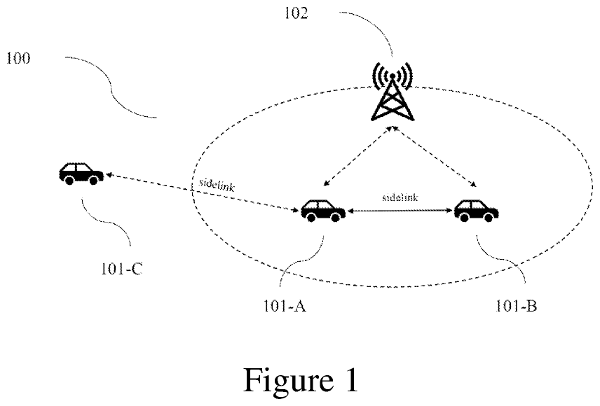

FIG. 1 illustrates an exemplary V2X communication system in accordance with some embodiments of the present application.

As shown in FIG. 1, the V2X communication system includes a base station, i.e., BS 102 and some V2X UEs, i.e., UE 101-A, UE 101-B, and UE 101-C. UE 101-A and UE 101-B are within the coverage of BS 102, and UE 101-C is not. UE 101-A and UE 101-B may perform sidelink unicast transmission, sidelink groupcast transmission, or sidelink broadcast transmission. It is contemplated that, in accordance with some other embodiments of the present application, a V2X communication system may include more or fewer BSs, and more or fewer V2X UEs. Moreover, it is contemplated that names of V2X UEs (which represent a Tx UE, a Rx UE, and etc.) as illustrated and shown in FIG. 1 may be different, e.g., UE 101c, UE 104f, and UE 108g or the like.

In addition, although each V2X UE as shown in FIG. 1 is illustrated in the shape of a car, it is contemplated that a V2X communication system may include any type of UE (e.g., a roadmap device, a cell phone, a computer, a laptop, IoT (internet of things) device or other type of device) in accordance with some other embodiments of the present application.

According to some embodiments of FIG. 1, UE 101-A functions as a Tx UE, and UE 101-B and UE 101-C function as a Rx UE. UE 101-A may exchange V2X messages with UE 101-B, or UE 101-C through a sidelink, for example, PC5 interface as defined in 3GPP TS 23.303. UE 101-A may transmit information or data to other UE(s) within the V2X communication system, through sidelink unicast, sidelink groupcast, or sidelink broadcast. For instance, UE 101-A transmits data to UE 101-B in a sidelink unicast session. UE 101-A may transmit data to UE 101-B and UE 101-C in a groupcast group by a sidelink groupcast transmission session. Also, UE 102 may transmit data to UE 101-B and UE 101-C by a sidelink broadcast transmission session.

Alternatively, according to some other embodiments of FIG. 1, UE 101-B functions as a Tx UE and transmits V2X messages, UE 101-A functions as a Rx UE and receives the V2X messages from UE 101-B.

Both UE 101-A and UE 101-B in the embodiments of FIG. 1 may transmit information to BS 102 and receive control information from BS 102, for example, via NR Uu interface. BS 102 may define one or more cells, and each cell may have a coverage area. As shown in FIG. 1, both UE 101-A and UE 101-B are within a coverage of BS 102, and UE 101-C is not.

BS 102 as illustrated and shown in FIG. 1 is not a specific base station, but may be any base station(s) in the V2X communication system. For example, if the V2X communication system includes two BSs 102, UE 101-A being within a coverage area of any one the two BSs 102 may be called as a case that UE 101-A is within a coverage of BS 102 in the V2X communication system; and only UE 101-A being outside of coverage area(s) of both BSs 102 can be called as a case that UE 101-A is outside of the coverage of BS 102 in the V2X communication system.

The V2X UEs may operate in different modes. At least two sidelink resource allocation modes are defined for NR-V2X sidelink communication, which are: mode 1: Base station schedules sidelink resource(s) to be used by UE for sidelink transmission(s); and mode 2: UE determines sidelink transmission resource(s) within sidelink resources configured by base station or network, or pre-configured sidelink resources, in mode 2, the Base station does not schedules the sidelink resources for the UE.

The subject disclosure focuses on mode 2. The mode 2 definition covers potential sidelink radio-layer functionality or resource allocation sub-modes where
a) UE autonomously selects sidelink resource for transmission;
b) UE assists sidelink resource selection for other UE(s);
c) UE is configured with NR configured grant (type-1) for sidelink transmission; and
d) UE schedules sidelink transmissions of other UEs.

It is agreed that the following aspects about assistance information are studied for mode 2(b): 1) which assistance information is used and how it is acquired; 2) which UE sends assistance information; 3) how to deliver assistance information, including physical channel and UE behaviour; and 4) how assistance information is taken into account in determination of sidelink resource for transmission.

It is also agreed that mode-2(b) to be studied as a functionality that can be a part of mode-2(a)(c)(d) operation, when one UE assists sidelink resource selection for other UE(s). It is noted that mode-2(b) is not supported or studied as a standalone sidelink resource allocation mode.

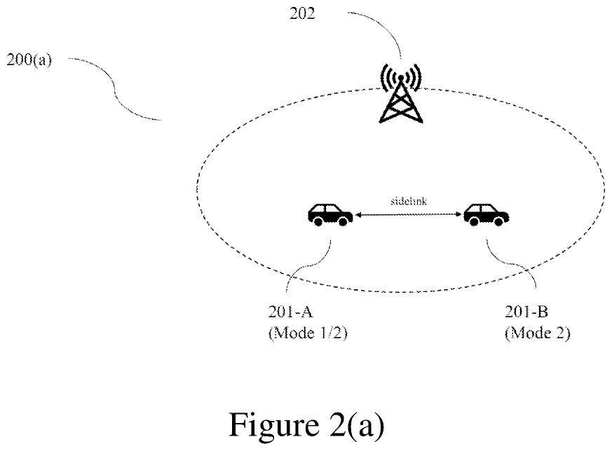

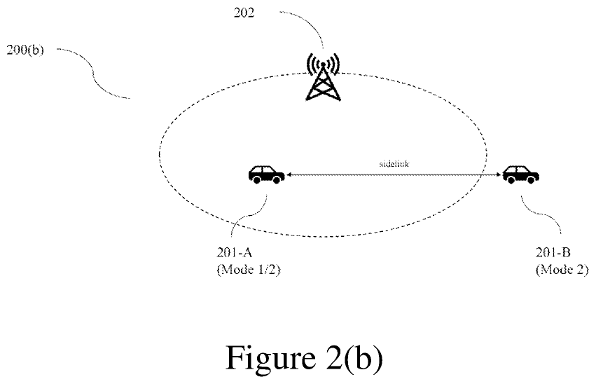

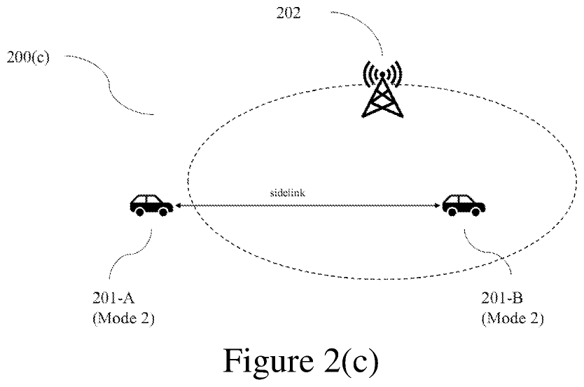

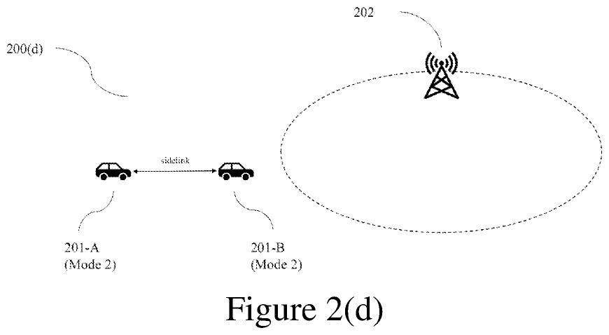

FIGS. 2(a), 2(b), 2(c), and 2(d) illustrates different scenarios of UEs in different modes depending on whether the UEs are within the coverage of the BS. In FIGS. 2(a)-2(d), the UE-201-B is always in mode 2.

In FIG. 2(a), both UE 201-A and 201-B are located within the coverage of BS 202, UE 201-A may be in mode 1 or mode 2, and UE 201-B is in mode 2. In FIG. 2(b), UE 201-A is located within the coverage of BS 202 and UE 201-B is not. UE 201-A may be in mode 1 or mode 2, and UE 201-B is in mode 2. In FIG. 2(c), UE 201-B is located within the coverage of BS 202 and UE 201-A is not. UE 201-A and UE 201-B are both in mode 2. In FIG. 2(d), UE 201-A and UE 201-B are both located outside the coverage of BS 202 and are both in mode 2.

According the agreed Work Item Description (WID) for sidelink enhancement, inter-UE coordination should be studied to enhance the reliability and reduce latency in consideration of both Packet Reception Ratio (PRR) and Packet Inter-Reception (PIR). The definition of inter-UE coordination in WID is: “A set of resources is determined at UE-A. This set is sent to UE-B in mode 2, and UE-B takes this into account in the resource selection for its own transmission.” That is, the UE 201-A in FIGS. 2(a)-2(d) determines a set of sidelink resources then transmit the same to UE 201-B, and UE 201-B takes the set of sidelink resources into account in the resource selection for its own transmission.

Regarding resource allocation enhancement, it is agreed to specify resource allocation to reduce power consumption of the UEs. The Baseline is to introduce the principle of Rel-14 LTE sidelink random resource selection and partial sensing to Rel-16 NR sidelink resource allocation mode 2. It should be noted that taking Rel-14 as the baseline does not preclude introducing a new solution to reduce power consumption for the cases where the baseline cannot work properly.

The subject disclosure aims to address the following issues related to inter-UE coordination:
i. UE 201-A determining of the set of sidelink resources;
ii. UE 201-A sending the set of sidelink resources to UE 201-B on sidelink;
iii. UE 201-A signaling the set of sidelink resources to UE 201-B on sidelink; and
iv. UE 201-B selecting the set of sidelink resources based on the received set of sidelink resources and the determined set of sidelink resources.

It should be noted that hereinafter in the subject disclosure, the reference numerals UE 201-A and UE 201-B are used to respectively refer to the UE 201-A and UE 201-B in all the scenarios in FIGS. 2(a)-2(d), and UE 101-A and UE 101-B in FIG. 1 as well.

There are several manners for a UE to determine the sidelink resources. When a UE is located within the coverage of a BS and is in mode 1, the sidelink resources of the UE may be scheduled by the BS. For example, in FIG. 2(a) and FIG. 2(b), the sidelink resources of UE 201-A can be determined by BS 202. For example, UE 201-A may be in communication with UE 201-B, and detects consecutive packet loss from UE 201-B. UE 201-A then sends an indicator to BS 202 to request a set of sidelink resources for UE 201-B's transmission. The indicator may include the information of UE 201-B, for instance, the ID of UE 201-B. After receiving this indicator from UE 201-A, BS 202 would transmit the set of sidelink resources to UE 201-B directly or indirectly. E.g., in FIG. 2(a), BS 202 could directly send the sidelink resources to UE 201-B. For another example, in FIGS. 2(a) and 2(b), BS 202 could send the sidelink resources to UE 201-A, and UE 201-A then transmits the sidelink resources to UE 201-B through sidelink communication. A BS can transmit the set of sidelink resources to a UE through Radio Resource Control (RRC) Signaling or (Downlink Control Information (DCI).

If there are separated resource pool for UEs in mode 1 and mode 2, the BS can allocate a set of sidelink resources in the resource pool for UEs in mode 1 to guarantee the reliability of UE 201-B's transmission.

When a UE is in mode 1 or mode 2, the sidelink resources of the UE may be determined by the UE. For example, UE 201-A in FIG. 2(a)-2(d) determines the sidelink resources for the sidelink transmission of UE 201-B

There are several manners for a UE to determine the sidelink resources, for example, the set of sidelink resources may be determined based on a communication status of the sidelink resources. A communication status of a sidelink resource includes transmitting status and a receiving status, which means the sidelink resource is used for transmitting, or for receiving.

One UE may receive a sidelink transmission from another UE, for example, in FIG. 1, UE 101-A receives a sidelink transmission from UE 101-C, and UE 101-C reserves some sidelink resources, for example, some slots. On these reserved slots, UE 101-A performs reception. UE 101-A can inform UE 101-B that UE 101-A will perform reception on these reserved slots, thus, UE 101-B can also transmit data to UE 101-A on these reserved slots, so as to reduce the probability of half-duplex.

UE 101-A may also transmit data packets to UE 101-B. The UE 101-A could sense the sidelink resources, for example, the UE 101-A could detect the Sidelink Control Information (SCI), then selects some sidelink resources to perform the transmission. In these selected sidelink resources, for instance, slots, UE 101-A will work in a transmission status, then UE 101-A can inform UE 101-B that UE 101-A would transmit on these selected slots. UE 101-B then would avoid to perform transmission to UE 101-A on these slots to reduce the probability of half-duplex.

For another example, the set of sidelink resources may be determined based on the sensing and measuring performed by the UE. More particularly, a UE can determine whether a sidelink resource is available or unavailable based on the SCI decoding and SL-RSRP measurement.

If a sidelink resource is not indicated by a SCI, then the sidelink resource is considered to be an available sidelink resource. If a sidelink resource is indicated by a SCI, but the value of the associated Layer 1 Sidelink-Reference Signal Received Power (L1 SL-RSRP) is less than or equal to a threshold, then the sidelink resource is also considered to be an available sidelink resource.

One the other hand, if a sidelink resource is indicated by a SCI, and the value of the associated L1 SL-RSRP is greater than a threshold, then the sidelink resource is unavailable, which means it might be occupied by another UE.

The SL-RSRP threshold may be fixed in specification, or configured by the BS, or pre-configured. The SL-RSRP threshold is at least a function of the priority of the sidelink transmission indicated in the received SCI and the priority of the transmission for which resources are being selected by the UE. The initial L1 SL-RSRP threshold for each combination of pᵢ and pⱼ is (pre-)configured, where pᵢ is a priority level associated with the resource indicated in SCI and pⱼ is a priority level of the transmission in the UE selecting resources. The priority level of the transmission in the UE selecting resources may be indicated by another UE For example, assuming UE 101-A in FIG. 1 receives a SCI indicated by UE 101-C, pᵢ is a priority level associated with the resource indicated in SCI from UE 101-C, and pⱼ is a priority level of the transmission of UE 101-B if the set of sidelink resources will be transmitted to UE 101-B. UE-101 B may transmit the information on pⱼ to UE-101-A

When the ratio of identified candidate resources to the total number of resources in a resource selection window, is less than a predefined percentage, for example, 20%, all configured thresholds are increased by 3 dB, or other number of dB, and the resource identification procedure is repeated.

Regarding sending the set of sidelink resources to another UE on sidelink, two sidelink physical channels, Physical Sidelink Control Channel (PSCCH) and Physical Sidelink Shared Channel (PSSCH), may be used to transmit the set of sidelink resources.

When PSCCH is used, the set of sidelink resources is transmitted in 1^{st}-stage SCI. New 1^{st}-stage SCI, e.g., SCI format 1-0, may be defined to transmit the set of resources; and it might increase the number of blind detections of 1^{st}-sage SCI. The set of sidelink resources can also be transmitted in 2^{nd}-stage SCI, and one new 2^{nd}-stage SCI format can be defined. It is noted that the 1^{st}-stage SCI is defined in R16, and it is benefit for blind detection.

If a UE has no data to be transmitted, standalone PSCCH may be used to transmit the set of sidelink resources.

When PSSCH is used, the set of resources can be transmitted in high layer signaling, for example, Media Access Control-Control Element (MAC-CE) or sidelink RRC signaling.

Regarding UE 201-A signaling the set of sidelink resources to UE 201-B on sidelink, the signaling approaches vary due to different motivations. Inter-UE coordination may have two motivations, one is to reduce the probability of half-duplex, and the other one is to reduce probability of resource collisions due to hidden node.

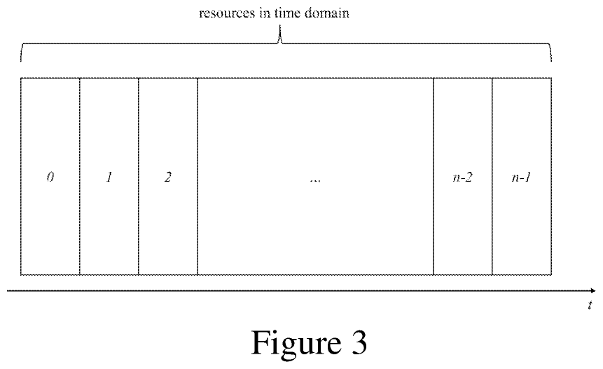

In order to reduce the probability of half-duplex, the subject disclosure proposes to configure the set of sidelink resources only contains time domain information. FIG. 3 illustrates one type of a set of sidelink resources in the subject disclosure, which only includes sidelink resources in time domain, thus only includes time domain information. For example, the sidelink resources in time domain may be time slots.

One UE can signal the set of resources to the other UE using the bitmap method. For example, as shown in FIG. 3, one UE can transmit n bits to another UE, with each bit represent the communication status of the corresponding slot. For example, the value ‘1’ indicates that the UE will perform reception on that slot, and the value ‘0’ represents that UE will perform transmission on the slot. Alternatively, the value ‘0’ can indicate that the UE will perform reception on that slot, and the value ‘1’ represents that UE will perform transmission on the slot.

The UE may utilize other methods to signal the set of sidelink resources, for example, the UE may indicate a list of slots to another UE. For each slot in the list, the UE transmits a time offset between the slot transmitting the set of resources and that slot. For example, for slot n in the list, the UE transmits the time offset between the slot transmitting the set of resources and slot n. The set of sidelink resources may be reception slots or transmission slots, a UE may also transmit an indicator to another UE to indicate the communication status of the set of resources, e.g., in SCI or high layer signaling in PSSCH.

In order to reduce probability of resource collisions due to hidden node, the set of sidelink resources contains both time domain and frequency domain information.

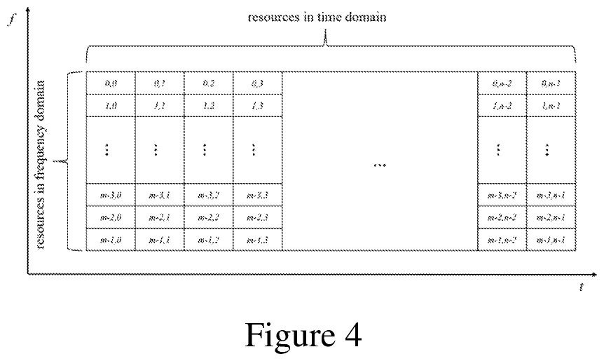

FIG. 4 shows one type of a set of sidelink resources in the subject disclosure, which includes both sidelink resources in time domain and sidelink resources in frequency domain, and thus includes both time domain information and frequency domain information. For example, the resources in time domain may be slots, and the sidelink resources in frequency domain might be sub-channels. The smallest granularity of resource can be one sub-channel and one slot. In FIG. 4, there are m sub-channels and n slots. Therefore, the number of sidelink resources is m×n.

The UE can still use the bitmap method to indicate the set of sidelink resources to another UE. Since the number of sidelink resources is m×n, then m×n bits are needed to indicate the set of sidelink resources to another UE, with each bit represent the communication status of the corresponding resource. The value ‘1’ indicates that the resource is available, and the value ‘0’ represents that the resource is unavailable. Alternatively, the value ‘0’ can indicate that the UE will perform reception on that resource, and the value ‘1’ represents that UE will perform transmission on the resource.

In order to reduce the size of the bitmap, the resources can be grouped. For example, the slots can be grouped or the sub-channels can be grouped. Please refer to FIG. 4 again. Suppose that two slots grouped and the sub-channels are not grouped, then one bit in the bitmap represents the status of one sub-channel and two slots. Therefore, the size of the bitmap is m×n/2, and the signaling overhead is reduced.

The UE can use other approaches to indicate the availability of the resource, for example, the UE can transmit a signal indicating a number of available slots to another UE, and also transmit the same number of bitmaps, each bitmap is used to indicate the frequency resource corresponding to one slot. Please refer to FIG. 4. For example, if slot 1, 2 and 3 are available and a bitmap for slot 1 indicating availability of resource (0, 1), (1, 1) . . . (m−1, 1) is provided; a bitmap for slot 2 indicating availability of resource (0, 2), (1, 2) . . . (m−1, 2) is provided; and a bitmap for slot 3 indicating availability of resource (0, 2), (1, 2) . . . (m−1, 2) is provided. The UE may transmit the above information to another UE, e.g., in SCI or high layer signaling in PSSCH.

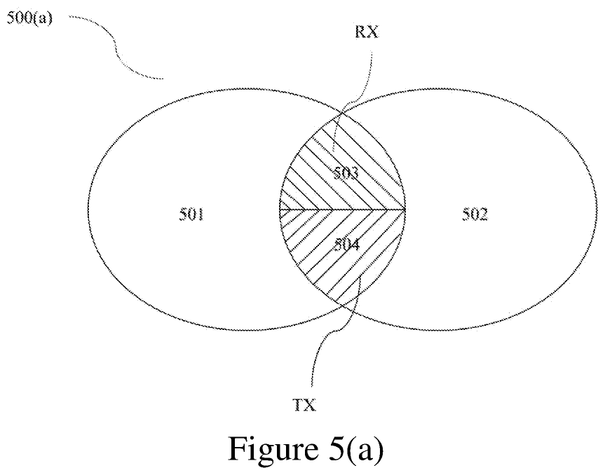

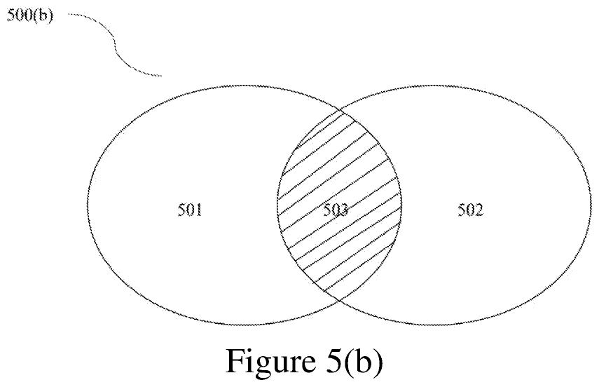

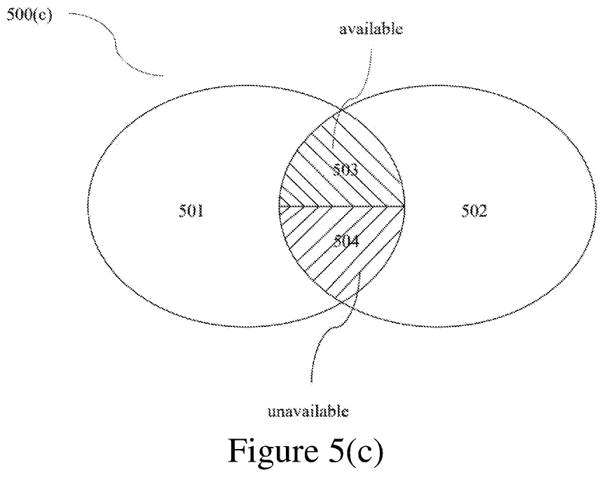

After UE 201-A signaling the set of sidelink resources to UE 201-B on sidelink, UE 201-B selects the set of sidelink resources based on the received set of sidelink resources and the determined set of sidelink resources. Different selection manners are presented in FIGS. 5(a), 5(b), and 5(c).

FIG. 5(a) depicts an exemplary selection method performed by UE 201-B. In FIG. 5(a), the left oval 501 represents the set of sidelink resources transmitted from UE 201-A, hereinafter referred to as Resources Set A, the right oval 503 represents the set of sidelink resources determined by UE 201-B, hereinafter referred to as Resources Set B, and the shaded portions 503 and 504 are the intersection of the Resources Set A and Resources Set B.

After UE 201-B receives Resources Set A from UE 201-A, UE 201-B can determine the sidelink resources based on Resources Set A and Resources Set B. According to different cases, UE 201-B would select the sidelink resources from Resources Set A and Resources Set B with different manners, and the details are presented as follows.

Case 1: Resources Set A only includes resources in time domain, and UE 201-A is the receiving UE of UE 201-B. Under this condition, UE 201-B should take the Resources Set A into consideration to reduce the probability of half-duplex. In particular, UE 201-B would select the resources which are indicated as reception slots in Resources Set A.

If Resources Set A includes both reception slots and transmission slots, UE 201-B then performs resource selection, for example, random selection, from a group that includes the intersection of resources indicated as reception slots in Resources Set A and Resources Set B. For example, as shown in FIG. 5(a), the left oval 501 represents Resources Set A, the right oval 502 represents Resources Set B, and the shaded portions 503 and 504 are the intersection of the Resources Set A and Resources Set B. The shaded portion 503 represents the reception slots in Resources Set A, which is marked by RX in FIG. 5(a), and the shaded portion 504 represents the transmission slots in Resources Set A, which is marked by TX in FIG. 5(a). Therefore, UE 201-B should select resource from the shaded portion 503, which is the intersection of resources indicated as reception slots in Resources Set A and Resources Set B.

The Resources Set A might include either reception slots or transmission slots, and if the Resources Set A only includes reception slots, UE 201-B then performs resource selection, for example, random selection, from the resources that are the intersection of Resources Set A and Resources Set B. If the Resources Set A only includes transmission slots, UE 201-B then should not transmit data to UE 201-A in these slots, and performs resource selection, for example, random selection, from a group that includes remaining Resources Set B after excluding the slots in Resources Set A. For example, in FIG. 5(b), the left oval 501 represents Resources Set A, the right oval 502 represents Resources Set B, and the shaded portion 503 is the intersection of the Resources Set A and Resources Set B. When the Resources Set A 501 only includes reception slots, then UE 201-B random selects resources from the resources set in the shaded portion 503. When the Resources Set A 501 only includes transmission slots, then UE 201-B random selects resources from the Resources Set 502 without resources in the shaded portion 503.

Case 2: Resources Set A only includes resources in time domain, and UE 201-A is not the receiving UE of UE B. Since UE 201-A is not the receiving UE of UE B, UE 201-B may ignore the Resources Set A during the resource selection process, and performs resource selection, for example, random selection from Resources Set B.

Alternatively, in order to not interfere other UE's transmission, UE 201-B can take Resources Set A into consideration even when UE 201-A is not the receiving UE of UE B.

If Resources Set A includes both reception slots and transmission slots, UE 201-B then performs resource selection, for example, random selection, from a group that includes the intersection of resources indicated as transmission slots in Resources Set A and Resources Set B. For example, as shown in FIG. 5(a), the left oval 501 represents Resources Set A, the right oval 502 represents Resources Set B, and the shaded portions 503 and 504 are the intersection of the Resources Set A and Resources Set B. The shaded portion 503 represents the reception slots in Resources Set A, and the shaded portion 504 represents the transmission slots in Resources Set A. Therefore, UE 201-B should select resource from the shaded portion 504, which is the intersection of resources indicated as transmission slots in Resources Set A and Resources Set B.

The Resources Set A might include either reception slots or transmission slots, and if the Resources Set A only includes transmission slots, UE 201-B then performs resource selection, for example, random selection, from the resources that are the intersection of Resources Set A and Resources Set B. If the Resources Set A only includes reception slots, UE 201-B then should not transmit data to UE 201-A in these slots, and performs resource selection, for example, random selection, from a group that includes remaining Resources Set B after excluding the slots in Resources Set A. For example, in FIG. 5(b), the left oval 501 represents Resources Set A, the right oval 502 represents Resources Set B, and the shaded portion 503 is the intersection of the Resources Set A and Resources Set B. When the Resources Set A 501 only includes transmission slots, then UE 201-B random selects resources from the resources in the shaded portion 503. When the Resources Set A 501 only includes reception slots, then UE 201-B random selects resources from the Resources Set 502 without the resources in the shaded portion 503.

Case 3: Resources Set A includes both time and frequency domain information resources in time domain, and UE 201-A is the receiving UE of UE B. Under this condition, UE 201-B should take the Resources Set A into consideration, to reduce the probability of hidden node. In particular, UE 201-B would select the resources which are indicated as available resources in Resources Set A.

If Resources Set A includes both available resources and unavailable resources, UE 201-B then performs resource selection, for example, random selection, from a group that includes the intersection of resources indicated as available resources in Resources Set A and Resources Set B. For example, as shown in FIG. 5(c), the left oval 501 represents Resources Set A, the right oval 502 represents Resources Set B, and the shaded portions 503 and 504 are the intersection of the Resources Set A and Resources Set B. The shaded portion 503 represents the available resources in Resources Set A, and the shaded portion 504 represents the unavailable resources in Resources Set A. Therefore, UE 201-B should select resource from the shaded portion 503, which is the intersection of resources indicated as available resources in Resources Set A and Resources Set B.

The Resources Set A might include either available resources or unavailable resources, and if the Resources Set A only includes available resources, UE 201-B then performs resource selection, for example, random selection, from the resources that are the intersection of Resources Set A and Resources Set B. If the Resources Set A only includes unavailable resources, UE 201-B then should not transmit data to UE 201-A in these resources, and performs resource selection, for example, random selection, from a group that includes remaining Resources Set B after excluding the unavailable resources in Resources Set A. For example, in FIG. 5(b), the left oval 501 represents Resources Set A, the right oval 502 represents Resources Set B, and the shaded portions 503 is the intersection of the Resources Set A and Resources Set B. When the Resources Set A 501 only includes available resources, then UE 201-B random selects resources from the Resources Set 503. When the Resources Set A 501 only includes unavailable resources, then UE 201-B random selects resources from the Resources Set 502 without Resources Set 503.

Case 4: Resources Set A includes both time and frequency domain information, and UE 201-A is not the receiving UE of UE B. Since UE 201-A is not the receiving UE of UE B, UE 201-B may ignore the Resources Set A during the resource selection process, and performs resource selection, for example, random selection from Resources Set B.

Alternatively, in order to not interfere other UE's transmission, UE 201-B can take Resources Set A into consideration even when UE 201-A is not the receiving UE of UE B.

If Resources Set A includes both available resources and unavailable resources, UE 201-B then performs resource selection, for example, random selection, from a group that includes the intersection of resources indicated as unavailable resources in Resources Set A and Resources Set B. For example, as shown in FIG. 5(c), the left oval 501 represents Resources Set A, the right oval 502 represents Resources Set B, and the shaded portions 503 and 504 are the intersection of the Resources Set A and Resources Set B. The shaded portion 503 represents the available resources in Resources Set A, and the shaded portion 504 represents the unavailable resources in Resources Set A. Therefore, UE 201-B should select resource from the shaded portion 504, which is the intersection of resources indicated as unavailable resources in Resources Set A and Resources Set B.

The Resources Set A might include either available resources or unavailable resources, and if the Resources Set A only includes available resources, UE 201-B then performs resource selection, for example, random selection, from Resources Set B after excluding the resources that belong to Resources Set A. If the Resources Set A only includes unavailable resources, UE 201-B may perform resource selection, for example, random selection, from the intersection of resources of Resources Set A and Resources Set B. For example, in FIG. 5(b), the left oval 501 represents Resources Set A, the right oval 502 represents Resources Set B, and the shaded portion 503 is the intersection of the Resources Set A and Resources Set B. When the Resources Set A 501 only includes unavailable resources, then UE 201-B random selects resources from the resources in the shaded portion 503. When the Resources Set A 501 only includes available resources, then UE 201-B random selects resources from the Resources Set 502 without the resources in the shaded portion 503.

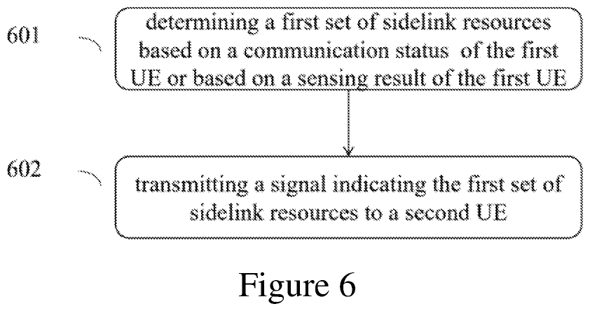

FIG. 6 illustrates a method performed by a first UE for sidelink communication according to a preferred embodiment of the subject disclosure. In step 601, a first UE determining a first set of sidelink resources based on a communication status of the first UE or based on a sensing result of the first UE. In step 602, the first UE transmitting a signal indicating the first set of sidelink resources to a second UE. For example, UE 201-A in FIG. 2(a) can determine a first set of sidelink resources based on the communication status of UE 201-A, then transmit a signal indicating the set of sidelink resources to UE 201-B. The communication status includes a transmitting status and a receiving status.

In one embodiment, UE 201-A determines that a sidelink resource is available when the sidelink resource is not indicated by a received SCI. Alternatively, the sidelink resource is considered available when the sidelink resource is indicated by a received SCI, and a value of the SL-RSRP measurement is less than or equal to a threshold. The sidelink resource is considered unavailable when the sidelink resource is indicated by a received SCI, and a value of the SL-RSRP measurement is greater than a threshold.

The threshold might be fixed in specification, or configured by a BS, or pre-configured. The initial threshold for UE 201-A and UE 201-B is determined by two parameters, pᵢ and pⱼ, wherein pᵢ is the priority level associated with the resource indicated in SCI of a UE, and pⱼ is the priority level of the transmission of UE 201-B. The priority level pj may be transmitted by UE 201-B to UE 201-A.

The set of sidelink resources includes sidelink resources in time domain, and the sidelink resources in time domain may be one or more slots. For example, the slots 0, 1, . . . , n−1 as shown in FIG. 3. UE 201-A may use a bitmap to indicate the communication status of UE 201-A on an associated sidelink resource; alternatively, UE 201-A may use a first indicator indicating one or more sidelink resources in time domain, and a second indicator indicating a same communication status of the first UE on the one or more sidelink resources. In other words, UE 201-A either indicates the transmitting slots or the receiving slots.

The set of sidelink resources includes sidelink resources in time domain and in frequency domain, the sidelink resources in one or more sub-channels and in one or more time slots. For example, the includes sidelink resources 0,0, 0,1, . . . , m−1, n−1 as shown in FIG. 4. UE 201-A may transmit a bitmap to UE 201-B, with each bit indicating whether an associated sidelink resource is available or unavailable. For example, the value ‘1’ indicates that the UE will perform reception on that slot, and the value ‘0’ represents that UE will perform transmission on the slot. Therefore, a bit map “1010” indicates the UE will perform reception on the first slot, transmission on the second slot, reception on the third slot, and transmission on the fourth slot.

Alternatively, UE 201-A may transmits an indicator indicating one or more sidelink resources in one or more time slots, and another indicator indicating one or more bitmaps, respectively corresponding to the one or more time slots, and each bitmap includes one or more bits, each indicates a sidelink resource in frequency domain in an associated time slot is available or unavailable. In other words, UE 201-A either indicates the available resources or the unavailable resources.

In one embodiment, the signal indicating the first set of sidelink resources is transmitted to the second UE in a stage of SCI. The stage of SCI may be 1^{st}-stage SCI or 2^{nd}-stage SCI. The signal indicating the first set of sidelink resources is transmitted to the second UE in Physical Sidelink Share Channel (PSSCH) using sidelink RRC signaling or sidelink MAC-CE.

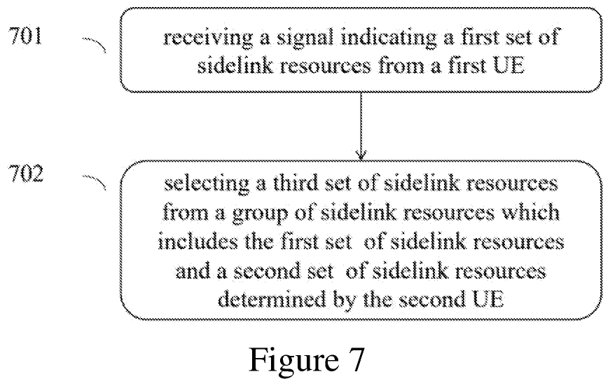

FIG. 7 illustrates a method performed by UE 201-B for sidelink communication according to a preferred embodiment of the subject disclosure. In step 701, UE 201-B receives a signal indicating a first set of sidelink resources from the first UE. In step 702, UE 201-B selects a third set of sidelink resources from a group of sidelink resources which includes the first set of sidelink resources and a second set of sidelink resources determined by the second UE. The second set of sidelink resources is determined by UE 201-B based on sensing, and the sensed sidelink resources in time domain comprise one or more time slots. For example, the slots 0, 1, n−1 as shown in FIG. 3.

UE 201-B may determine the communication status of UE 201-A on each sidelink resource of the first set of sidelink resources based on the signal indicating a first set of sidelink resources, the communication status comprises a transmitting status and a receiving status. In other words, a sidelink resource is used for transmitting or for receiving.

In one embodiment, the signal indicating the first set of sidelink resources comprises a bitmap, and each bit in the bitmap indicates the communication status of UE 201-A on an associated sidelink resource. For example, the value ‘1’ indicates that the UE will perform reception on that slot, and the value ‘0’ represents that UE will perform transmission on the slot. Therefore, a bit map “1010” indicates the UE will perform reception on the first slot, transmission on the second slot, reception on the third slot, and transmission on the fourth slot. Alternatively, the signal includes two indicators, the first indicator indicates one or more sidelink resources in time domain, and the second indicator indicates the same communication status of the first UE on the one or more sidelink resources. For example, the first indicator includes some sidelink resources, and the second indicator indicates that these sidelink resources are for transmitting.

Based on the set of sidelink resources only includes time domain information, depending on whether UE 201-A is a receiving UE for UE 201-B, UE 201-B selects the set of sidelink resources as follows: if UE 201-A is a receiving UE for UE 201-B, the third set of sidelink resources is selected from intersection of the second set of sidelink resources and one or more sidelink resources relating to receiving status in the first set of sidelink resources. For example, in FIG. 500(a), UE 201-B select resource from the shaded portion 503, which is the intersection of resources indicated as reception slots in Resources Set A and Resources Set B.

If UE 201-A is not a receiving UE for UE 201-B, the set of sidelink resources is selected from the second set of sidelink resources. For example, in FIG. 500(a), UE 201-B selects resource from the right oval 502, which is Resources Set B. Alternatively, UE 201-B can select resource from intersection of the second set of sidelink resources and one or more sidelink resources relating to transmitting status in the first set of sidelink resources, which is shaded portion 504, which is the intersection of resources indicated as transmission slots in Resources Set A and Resources Set B.

The first set of sidelink resources comprises one or more sidelink resources in time domain and in frequency domain, and may be in one or more sub-channels and in one or more time slots. For example, the sidelink resources as shown in FIG. 4.

In one embodiment, the signal indicating the first set of sidelink resources comprises a bitmap, and each bit in the bitmap indicates an associated sidelink resource is available or unavailable. Alternatively, the signal may include two indicators, the first indicator indicating one or more sidelink resources in one or more time slots, and the second indicator indicating one or more bitmaps, respective corresponding to the one or more time slots, and each bitmap includes one or more bits, each indicates a sidelink resource in frequency domain in an associated time slot is available or unavailable. For example, the first indicator includes some sidelink resources, and the second indicator indicates that these sidelink resources are unavailable.

Based on the set of sidelink resources only includes both time domain information and frequency domain information, depending on whether UE 201-A is a receiving UE for UE 201-B, UE 201-B selects the set of sidelink resources as follows: if UE 201-A is a receiving UE for UE 201-B, the set of sidelink resources is selected from intersection of the second set of sidelink resources and one or more sidelink resources indicated as available in the first set of sidelink resources. For example, UE 201-B selects sidelink resources from the resources in the shaded portion 503 in FIG. 5(c).

If UE 201-A is not a receiving UE for UE 201-B, the set of sidelink resources is selected from the second set of sidelink resources. Alternatively, if UE 201-A is not a receiving UE for UE 201-B, the set of sidelink resources is selected from intersection of the second set of sidelink resources and sidelink resources indicated as unavailable in the first set of sidelink resources. For example, UE 201-B selects sidelink resources from the resources in the shaded portion 504 in FIG. 5(c).

In one embodiment, the second UE may further receive a fourth set of sidelink resources from a Base Station.

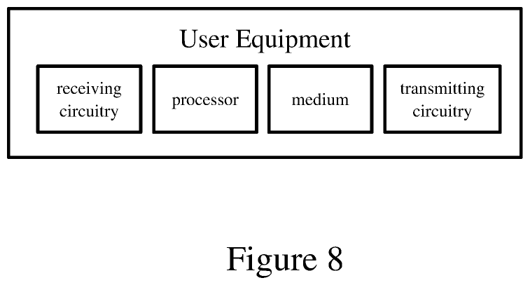

FIG. 8 illustrates a block diagram of a UE according to the embodiments of the subject disclosure. The UE may include a receiving circuitry, a processor, and a transmitting circuitry. In one embodiment, the UE may include a non-transitory computer-readable medium having stored thereon computer-executable instructions; a receiving circuitry; a transmitting circuitry; and a processor coupled to the non-transitory computer-readable medium, the receiving circuitry and the transmitting circuitry. The computer executable instructions can be programmed to implement a method (e.g. the methods in FIGS. 6 and 7) with the receiving circuitry, the transmitting circuitry and the processor. That is, the processor may determine a first set of sidelink resources based on a communication status of the first UE or based on a sensing result of the first UE, and the transmitting circuitry may transmit a signal indicating the first set of sidelink resources to a second UE.

The method of the present disclosure can be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

What is claimed is:

1. An apparatus, comprising:
a receiving circuitry;
a transmitting circuitry; and
a processor coupled to the receiving circuitry and the transmitting circuitry configured to cause the apparatus to:
determine a first set of sidelink resources based on one or more of a communication status of a first User Equipment (UE) or a sensing result of the first UE; and
transmit a signal indicating the first set of sidelink resources to a second UE.

2. The apparatus of claim 1, wherein the communication status comprises a transmitting status and a receiving status.

3. The apparatus of claim 1, wherein to determine the first set of sidelink resources based on the sensing result of the first UE, the processor coupled to the transmitting circuitry is further configured to cause the apparatus to:
determine a sidelink resource is available when the sidelink resource is not indicated by a received Sidelink Control Information (SCI).

4. The apparatus of claim 1, wherein to determine the first set of sidelink resources based on the sensing result of the first UE, the processor coupled to the transmitting circuitry is further configured to cause the apparatus to:
determine a sidelink resource is available when the sidelink resource is indicated by a received Sidelink Control Information (SCI) and a value of a Sidelink Reference Signal Received Power (SL-RSRP) measurement is less than or equal to a threshold.

5. The apparatus of claim 1, wherein the processor coupled to the transmitting circuitry is further configured to cause the apparatus to determine that a sidelink resource is unavailable when the sidelink resource is indicated by a received Sidelink Control Information (SCI) and a value of a Sidelink Reference Signal Received Power (SL-RSRP) measurement is greater than a threshold.

6. (canceled)

7. The apparatus of claim 5, wherein the processor coupled to the transmitting circuitry is further configured to cause the apparatus to determine the threshold based at least in part on a priority level transmitted from the second UE.

8. The apparatus of claim 1, wherein the first set of sidelink resources comprises sidelink resources in time domain.

9. The apparatus of claim 8, wherein the sidelink resources in time domain comprise one or more time slots.

10. The apparatus of claim 8, wherein the signal indicating the first set of sidelink resources comprises a bitmap, and each bit in the bitmap indicates the communication status of the first UE on an associated sidelink resource.

11-18. (canceled)

19. An apparatus, comprising:
a receiving circuitry;
a transmitting circuitry; and
a processor coupled to the receiving circuitry and the transmitting circuitry configured to cause the apparatus to:
receive, at a second User Equipment (UE), a signal indicating a first set of sidelink resources from a first UE; and
select a third set of sidelink resources from a group of sidelink resources which includes the first set of sidelink resources and a second set of sidelink resources determined by the second UE.

20. The apparatus of claim 19, wherein the processor coupled to the receiving circuitry and the transmitting circuitry is configured to cause the apparatus to:
determine the second set of sidelink resources based on a sensing result of the second UE.

21. The apparatus of claim 19, wherein the first set of sidelink resources comprises sidelink resources in time domain.

22. The apparatus of claim 21, wherein the sidelink resources in time domain comprise one or more time slots.

23. The apparatus of claim 19, wherein the processor coupled to the receiving circuitry and the transmitting circuitry is configured to cause the apparatus to:
determine a communication status of the first UE on each sidelink resource of the first set of sidelink resources based on the signal indicating the first set of sidelink resources.

24. The apparatus of claim 23, wherein the communication status comprises a transmitting status and a receiving status.

25. The apparatus of claim 23, wherein the signal indicating the first set of sidelink resources comprises a bitmap, and each bit in the bitmap indicates the communication status of the first UE on an associated sidelink resource.

26. The apparatus of claim 23, wherein the signal indicating the first set of sidelink resources comprises:
a first indicator indicating one or more sidelink resources in time domain; and
a second indicator indicating a same communication status of the first UE on the one or more sidelink resources.

27. The apparatus of claim 23, wherein the processor coupled to the receiving circuitry and the transmitting circuitry is configured to cause the apparatus to:
determine that the first UE is a receiving UE for the second UE; and
select the third set of sidelink resources from intersection of the second set of sidelink resources and one or more sidelink resources relating to receiving status in the first set of sidelink resources.

28-39. (canceled)

40. A method performed by a first User Equipment (UE), comprising:
determining a first set of sidelink resources based on a communication status of the first UE or based on a sensing result of the first UE; and
transmitting a signal indicating the first set of sidelink resources to a second UE.

41. The method of claim 40, wherein the communication status comprises a transmitting status and a receiving status.
